(19) United States
(12) Patent Application Publication
(10) Pub. No.: US 2026/0340327 A1
(43) Pub. Date: Oct. 29, 2026

(54) WIRELESS BACKSCATTER FIDUCIAL TAG AND RADAR DECODING SYSTEM

(71) Applicant: The Regents of the University of California, Oakland, CA (US)

(72) Inventors: Manideep Dunna, San Diego, CA (US); Kshitiz Bansal, La Jolla, CA (US); Sanjeev Anthia Ganesh, Santa Clara, CA (US); Eamon Patamasing, La Jolla, CA (US); Dinesh Bharadia, San Diego, CA (US)

(21) Appl. No.: 19/101,681

(22) PCT Filed: Aug. 8, 2023
(86) PCT No.: PCT/US2023/071832

§ 371 Date: Feb. 6, 2025

Related U.S. Application Data
(60) Provisional application No. 63/397,640, filed on Aug. 12, 2022.

(51) Int. Cl. G06K 7/10; G01S 13/42

(52) U.S. Cl. CPC G06K 7/10366; G01S 13/42

(57) ABSTRACT

A wireless backscatter fiducial tag includes a Van-Atta array having a plurality of antenna patches connected by a plurality of transmission lines. A signal control device controls transmissions from the Van-Atta array. A controller provides an identification signature of the tag to the signal control device. The identification signature defines a code. The signal control device can be RF switches. The identification signature can be a spreading code configured to be orthogonal to codes of other backscatter fiducial tags being used in a system with the backscatter fiducial tag. The controller can consist of fixed shift register outputting a repeating sequence of Gold code bits as the identification signature.

### PRIORITY CLAIM AND REFERENCE TO RELATED APPLICATION

The application claims priority under 35 U.S.C. § 119 and all applicable statutes and treaties from prior U.S. provisional application Ser. No. 63/397,640, which was filed Aug. 12, 2022.

### FIELD

A filed of the invention is low power RF backscatter communications. An example application of the invention is to traffic infrastructure, such as application to traffic control devices to assist automotive driving systems. Another application is to robotics, including indoor and outdoor systems in which robots are assisted by application of the invention to objects and/or locations.

### BACKGROUND

Millimeter wave (mmwave) radar sensing has made significant advancements with applications in both indoor and outdoor areas. It has found indoor applications in people counting, building security, smart home devices and health monitoring. Outdoor applications include blind spot detection, adaptive cruise control, traffic monitoring and drone perception, mmwave radars are pervasive in everyday life.

Mmwave radars are particularly useful in visually adverse conditions. Applications that require identifying objects in an environmental-independent environment include the detection of traffic signs, e.g. stop signs in poor weather conditions. See, Chiung-Yao Fang, et al, “Road-sign detection and tracking,” IEEE transactions on vehicular technology 52, 5 (2003), 1329-1341. Another application is detection of fire extinguishers in low visibility conditions like smoke and fire. See, Joseph W Starr and BY Lattimer, “Evaluation of navigation sensors in fire smoke environments,” Fire Technology 50, 6 (2014), 1459-1481. Generally, radars provide a longer range than cameras, especially in visually challenging conditions. See, Michael Meyer and Georg Kuschk, “Automotive radar dataset for deep learning based 3d object detection,” In 2019 16th European radar conference (EuRAD). IEEE, 129-132.

Despite recognized advantages of mmwave radar, current mmwave radar systems do not excel at object identification. This limitation arises from poor scattering performance and the lack of an identifying signature such as color. Poor scattering performance will limit the power reflected back towards the mmwave radar from a small object such as a stop sign. The radar return lacks rich color information provided by a camera, which could help identify a particular object if sufficient power were reflected back. These physical limitations of mmwave can't be overcome by processing alone. Common state of the art systems therefore rely on cameras for applications that require both detection and identification of any object.

Millimetro is a an ultra-low-power tag that can be localized at high accuracy over extended distances to aid object detection in autonomous driving applications. Soltanaghaei et al, “Millimetro: mmWave Retro-Reflective Tags for Accurate, Long Range Localization,” MobiCom '21: Proceedings of the 27th Annual International Conference on Mobile Computing and Networking (2021) Pages 69-82. The described system used a Van Atta retro-directive array is a passive design that reflects back any incident wave in reverse, parallel to the direction of incidence. Tags are identified by searching for the unique signature of Van Atta modulations in the range-Doppler domain. The range and angular resolutions are limited by chirp bandwidth and the number of receiving antennas. Millimetro tags can have a long detection latency, up to 5 ms, because slow modulation frequencies are used, which show their effect over an entire frame. This requires examination of an entire radar frame (that consists of ~100 chirps).

### SUMMARY OF THE INVENTION

A wireless backscatter fiducial tag includes a Van-Atta array having a plurality of antenna patches connected by a plurality of transmission lines. A signal control device controls transmissions from the Van-Atta array. A controller provides an identification signature of the tag to the signal control device. The identification signature defines a code. The signal control device can be RF switches. The identification signature can be a spreading code configured to be orthogonal to codes of other backscatter fiducial tags being used in a system with the backscatter fiducial tag. The controller can consist of fixed shift register outputting a repeating sequence of Gold code bits as the identification signature.

### BRIEF DESCRIPTION OF THE DRAWINGS

FIG. 1 shows a preferred system of the invention using two unique fiducial backscatter tags;

FIG. 2 illustrates multiple categories of tags of the invention can each have a unique code and be detected via correlation;

FIGS. 3A-3D illustrate code modulation of a preferred fiducial backscatter tag of the invention;

FIG. 4 shows a radar processing flow in a preferred decoder of the invention;

FIG. 5A shows a general correlation process used in a preferred decoder of the invention;

FIGS. 5B-5E shows how a preferred tag code is constructed for automotive radar;

FIGS. 6A-6C empirically show that the cross-correlation contribution from the image signal becomes smaller as time-of-flight increases;

FIG. 7A shows preferred backscatter fiducial tag hardware;

FIG. 7B show how design of a Van Atta array antenna and transmission line connections affect width and distance of the backscatter fiducial tag's reflected signal; and

FIGS. 8A-8F show curves for the performance of decoder detection and identification in the presence of multiple backscatter fiducial tags.

### DETAILED DESCRIPTION OF THE PREFERRED EMBODIMENTS

A preferred embodiment is a wireless backscatter fiducial tag includes a Van-Atta array having a plurality of antenna patches connected by a plurality of transmission lines. A signal control device controls transmissions from the Van-Atta array. A controller provides an identification signature of the tag to the signal control device. The identification signature defines a code. The signal control device can be RF switches. The identification signature can be a spreading code configured to be orthogonal to codes of other backscatter fiducial tags being used in a system with the backscatter fiducial tag. The controller can consist of fixed shift register outputting a repeating sequence of Gold code bits as the identification signature

Preferred embodiments provide a backscatter fiducial tag employing an encoding scheme that permits radar detection and identification of the tag with very low latency. A preferred backscatter tag and decoding method permits the tag detection/identification in a single radar chirp duration (100 μs), and other preferred tags increase accuracy, for example when used with radar systems that have digital beam-forming, by combining multiple chirps. Preferred tags are uniquely identifiable even in real-world environments.

Experiments showed that preferred backscatter fiducial tags provide low latency with high reliability. Prototype tags can be reliably detected with a 100% detection rate up to 25 m and up to 120 degrees field of view with a latency of the order of milliseconds.

A preferred backscatter fiducial tag implements modulation with RF switches in a Van-Atta array, which turns ON/OFF the reflections in a flashing modulation, similarly to RFID tags. To maintain compatibility with commercially available radars, including the ones that perform analog beamforming to scan each spatial direction one at a time, the modulation is configured to be read in a very short duration of time. To support low latency along with robust detection, CDMA style codes are employed as the identity of the tag, which can modulate the entire code within the span of a single chirp of the radar. Preferred tags use gold codes, which are orthogonal to each other and uniquely identifiable. The code enables robust detection in real-world traffic scenarios while also supporting multiple tags operation. With single chip detection capability, the tag is compatible with the beamforming radars.

A preferred backscatter fiducial tag implements three features. One is a Van-Atta array design to enable retro-directivity so that a reader radar can read it from a wide range of angles. Secondly, the tag distinguishes itself from other objects encountered on roads by creating a unique signature in form of a switching frequency. The switching frequency is the ON/OFF cycle, and the code sits on top of that where each cycle can have two different phases (0 and 180 degrees) representing 0 and 1 bits. Each tag is encoded using a specific code, that creates a specific identity for each tag (e.g, stop sign, traffic light). Using a code-based identification provides scalability required to support multiple tags working simultaneously.

A preferred traffic system includes a plurality of backscatter fiducial tags of the invention, each having a predetermined unique signature, and each attached to a different typic of traffic control device. For example, tags attached to stop signs have different unique signatures than tags attached to merge signs.

Compared to millimetro, which requires a full radar frame, present embodiments can use a single (in-chirp) code division multiplexing modulation (or a few chirps to improve accuracy). The present CDM methods outperform the detection rate of the FM scheme as it does not get affected by clutter from the vehicle. The present CDM methods provide higher reliability, keep the latency of detection low, and allow the capability of getting processing gain by using longer than a single chirp observation time. Phase level matching in preferred methods and systems provides the optimal SNR for detection, which is always better than amplitude based absolute matching in FM schemes, similar to the optimality of co-phasing in maximal ratio combining. Preferred methods outperform the methods discussed in the background when doppler clutter is present or when the signal becomes weaker at longer distances.

Preferred embodiments of the invention will now be discussed with respect to experiments and drawings. Broader aspects of the invention will be understood by artisans in view of the general knowledge in the art and the description of the experiments that follows.

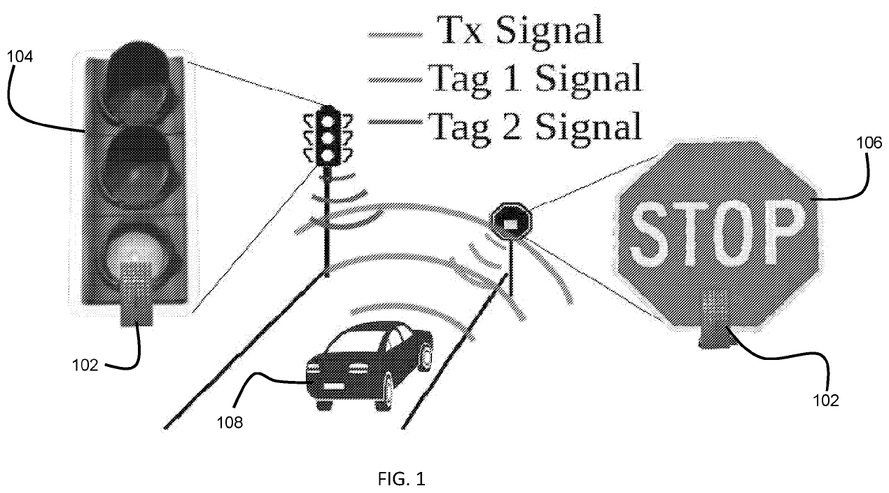

FIG. 1 shows an example system using two unique backscatter fiducial tags 102 of the invention. One of the tags 102 is attached to a traffic light 104 and the other to a stop sign 106. The tags 102 each have a unique category code, meaning tags for stop signs can have the same code as other stop signs and tags for traffic lights can have the same code as other traffic lights. In the example autonomous driving system shown in FIG. 1, each different type of traffic control device will have a unique backscatter fiducial tag 102 of the invention, which permits a vehicle system 108 to detect the type of traffic control device with mmWave radar in a single chirp period.

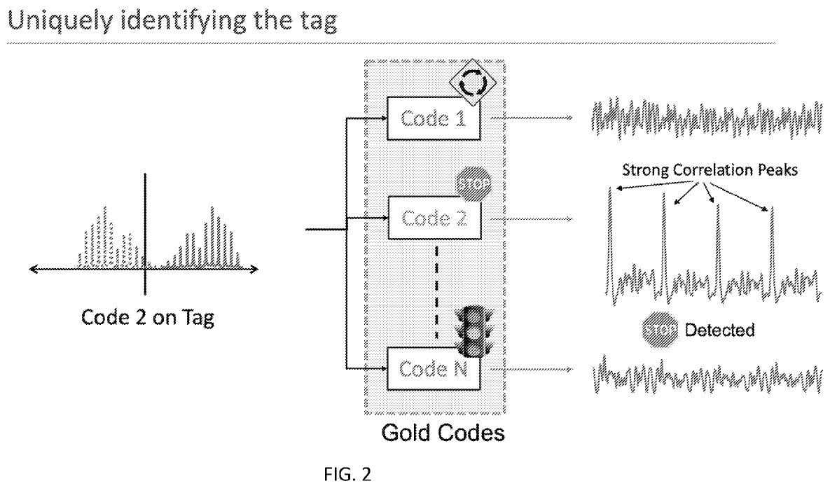

FIG. 2 shows that multiple categories of tags each have a unique code, Code 1-Code N. When the signal returns after backscattering from a tag that modulates Code 2, the system receiving the reflected signal will detect a series of peaks after correlation with Code 2, and thereby identify a device, e.g., a stop sign (or in another environment a fire extinguisher, door or table as a robot navigates an environment) that has been assigned Code 2.

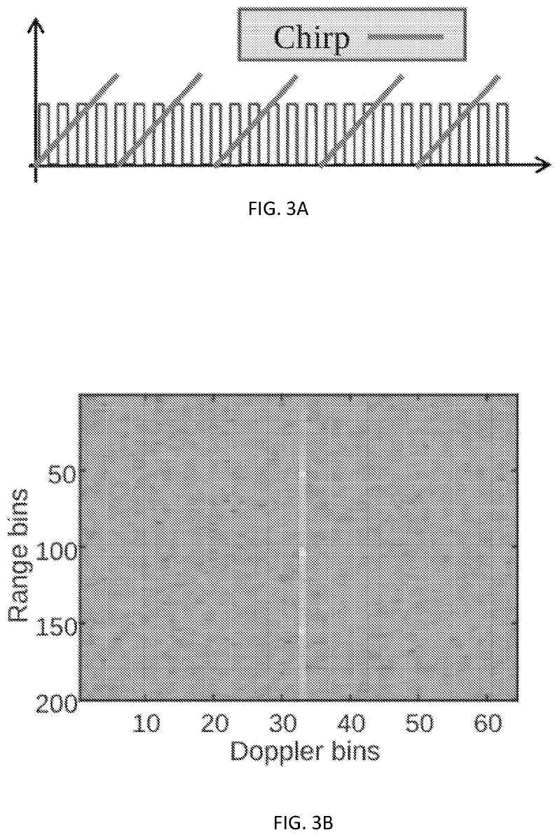

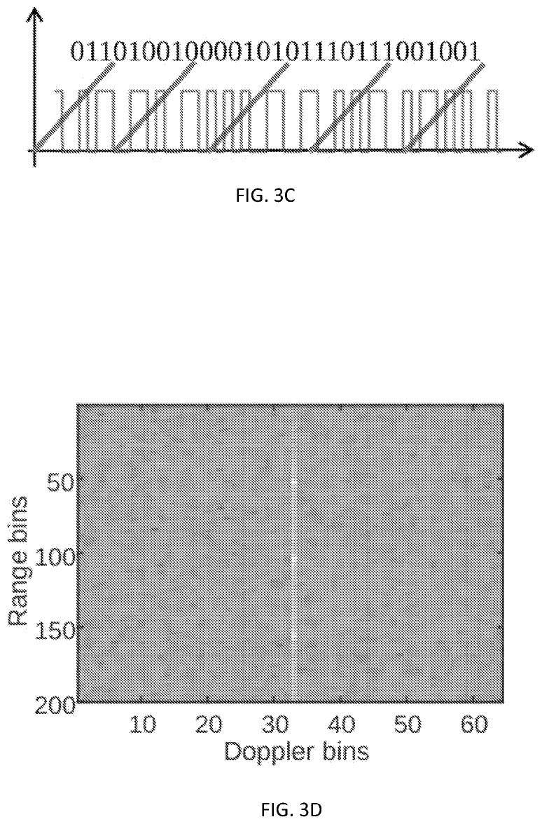

FIGS. 3A-3D illustrate modulation of a preferred backscatter fiducial tag of the invention. The modulation shown in FIGS. 3A-3B is a low latency in-chirp square wave modulation and its Range-Doppler FFT shows the harmonics occupying only a few range bins. FIGS. 3C-3D show low latency spread spectrum code modulated on every chirp to resolve collisions between tags. Range-Doppler FFT shows the code encodes tag modulation across the whole range bins providing reliable detection of tags.

The spreading codes of two backscatter fiducial tags of different categories are nearly orthogonal to each other and the tags signals can be separated from each other similar to how user signals are separated in CDMA. The invention provides spreading codes that can be associated with backscatter tags having a fiducial function, to identify a type of object that the tag is associated with, allowing simultaneous multi-tag operation to identify specific objects. Each of the spreading codes is an N-bit sequence that takes values in +1,0 with good auto-correlation and very low cross-correlation with other spreading codes. One cycle of ON/OFF switching creates one bit. The bit is encoded in phase. After the N-bits of the code complete, the code repeats itself. One ON/OFF cycle can be multiplied with 0 phase to signify 0 bit OR multiplied by 180 phase to signify 1 bit. These spreading codes continuously repeat on the tag and modulate the backscattered signal. In this way, a spreading code serves as the characteristic property of the backscatter fiducial tag and helps a decoder to isolate a tag's backscatter signal from the reflections due to other tags as well as other objects in the surroundings.

To see how the codes help in distinguishing two different backscatter fiducial tags, consider that two tags are using codes C₁[n] and C₂[n]. Reflected chirps from the tags contain code1 C₁[n] and code2 C₂[n] periodically repeating on them giving rise to [C₁[n]C₁[n] . . . . C₁[n]]+[C₂[n] C₂[n] . . . . C₂[n]] at the receiver. Upon cross-correlating the received signal with C₁[n], the resulting correlation is dominated by code1 when C₂[n] is very weakly correlated with C₁[n]. The cross-correlation looks like a series of impulses with k peaks where k is the number of code repetitions in a chirp duration. Similar observations can be made when correlating with the code C₂. The periodicity of these peaks in the cross-correlation helps the decoder identify the presence of a particular backscatter fiducial code.

$$\begin{matrix}Cross - correlation = {C}_{1} [ n ] * [ {C}_{1} [ n ] {C}_{1} [ n ] … {C}_{1} [ n ] ] + \\ {C}_{1} [ n ] * [ {C}_{2} [ n ] {C}_{2} [ n ] … {C}_{2} [ n ] ] \\ \approx {\sum }_{l = 0}^{l = k} δ [ n - lN ] + 0\end{matrix}$$

To incorporate these spreading codes onto the tag's backscattered signal, the modulation signal m(t) is modified to contain the N-bit spreading code. Each bit modulates the phase of the square wave pattern. A bit of value 1 corresponds to the ON to OFF transition of the tag with period

$$\frac{1}{{f}_{m}} .$$

Similarly, a bit of value 0 corresponds to OFF to ON transition of the tag with period

$$\frac{1}{{f}_{m}} .$$

The modulation signal is generated by appending the phase-modulated square waves corresponding to each bit as shown in FIG. 3C.

Each bit has a period equal to T_{bit}=1/fₘ and occupies a bandwidth of

$$\frac{2}{{T}_{bit}} = 2 {f}_{m} .$$

The bit sequence c(t) occupies is made up of N bits and occupies a total bandwidth of 2fₘ. Then the modulation signal m(t) is the bit sequence c(t) multiplied by the square wave of frequency fₘ. We observe that m(t) contains copies of c(t) centered at fₘ and −fₘ thus occupying a total bandwidth of 4fₘ.

$$\begin{matrix}m ( t ) = c ( t ) \times square wave of freq {f}_{m} \approx c ( t ) \times \frac{2}{π} cos ( 2 π {f}_{m} t ) \\ = \frac{c ( t )}{π} \times [ {e}^{j 2 π {f}_{m} t} + {e}^{- j 2 π {f}_{m} t} ]\end{matrix}$$

Choice of Modulation frequency: The above shows that the modulation signal depends on the frequency fₘ and the code c(t). A selected modulation frequency fₘ has consequences on the backscattered signal spectrum. The modulation signal m(t) has 2 copies of c(t) centered at fₘ, −fₘ. Each copy has a bandwidth fₘ and m(t) occupies a total bandwidth of 4fₘ. The modulation constraints arise because of the following conditions: (a) Each backscattered chirp contains k repetitions of the code and (b) a radar's Analog to Digital converter (ADC) has a finite sampling rate of fₛ. To meet the first condition, the bit duration in each code should be adjusted to ensure k code repetitions in a chirp duration T_{c}. A code contains N-bits each of duration

$$\frac{1}{{f}_{m}} ,$$

so each code occupies a length of N/fₘ. Hence the chirp duration T_{c} must be greater than k code durations leading to the timing constraint given by the following inequality.

$${T}_{c} > k \frac{N}{{f}_{m}} ⟹ {f}_{m} > k \frac{N}{{T}_{c}}$$

For the radar to be able to capture the modulated signal, the spectrum of the modulating signal must lie within the bandwidth of the ADC. Since the modulating signal m(t) occupies 4fₘ bandwidth, it leads to bandwidth constraint as given by following inequality.

$$4 {f}_{m} < {f}_{s} ⟹ {f}_{m} < \frac{{f}_{s}}{4}$$

For a given chirp duration and the radar's sampling frequency, the modulation frequency fₘ must be chosen to satisfy both the timing and bandwidth constraints.

Choice of Spread Spectrum Codes: To scale the present backscatter fiducial tag to sensing applications involving multiple tags, a unique spread spectrum code (a pseudo-random bit sequence) is assigned to each backscatter fiducial tag type (e.g., one type for yield signs and another for stop signs). To have good autocorrelation and cross-correlation properties between the codes, preferred tags use Gold codes, which are commonly used in CDGA and GPS. See, Robert Gold. “Maximal recursive sequences with 3-valued recursive cross-correlation functions,” IEEE transactions on Information Theory 14, 1 (1968), 154-1561; Esmael H Dinan and Bijan Jabbari, “Spreading codes for direct sequence CDMA and wideband CDMA cellular networks,” IEEE communications magazine 36, 9 (1998), 48-54; James J Spilker Jr. “GPS signal structure and performance characteristics,” Navigation, 25, 2 (1978), 121-146.

Gold code sequences can have different lengths. In a system of the invention, questions to resolve are how to choose the length of Gold sequences and how many backscatter fiducial tags can be simultaneously used for the choice of Gold codes?

Gold codes are generated by XORing the outputs of two m-bit Linear feedback shift registers. For an m-bit shift register, the length of the Gold code generated is 2^{m}−1. In total, 2^{m}+1 unique Gold code sequences are generated by loading the shift registers with different initial conditions. Since these codes are not perfectly orthogonal, not all the unique code sequences can be used. The ratio between auto-correlation of a gold sequence and cross-correlation with other gold sequences is a measure of orthogonality for these pseudo-random sequences. When multiple tags are in use, the cross-correlation between the codes starts to approach the same level as the auto-correlation and the orthogonality measure between the codes starts diminishing. As long as the cross-correlation of a code with other codes/tags being used is below the auto-correlation, more tags can be added to the system. Gold codes have a special property that the cross-correlation between two sequences takes just 3 different values and the maximum of the 3 values is.

$${2}^{\frac{m + 1}{2}} + 1$$

The peak value of the auto-correlation for a gold-sequence is 2^{m}−1 and for every new tag/code introduced into the system, the cross-correlation starts increasing almost by a factor

$${2}^{\frac{m + 1}{2}} + 1.$$

The total number of simultaneously usable codes (Nc) to maintain auto-correlation peak more than the cross-correlation is given by

$$\frac{{2}^{m} - 1}{{2}^{\frac{m + 1}{2}} + 1} \approx {2}^{\frac{m - 1}{2}} .$$

For instance, if we choose m=3 bit shift register, 2 tags can be simultaneously supported. It can be extended to support a higher number of tags by selecting a higher length shift register.

Compatibility with radar modes: A unique advantage of using the In-chirp spread spectrum modulation is its compatibility with all modes of radar. The single chirp operation not only provides low latency but also allows a seamless operation with analog beamforming radars. In analog beamforming radars, a chirp is directed to different angles to scan the entire scene. If the modulation requires multiple chirps to operate, it would be completely missed by an analog beamforming radar. Hence, the unique design of backscatter fiducial tag's modulation fulfills the requirement of compatibility with all radar modes.

### Detection and Localization of Backscatter Fiducial Tags

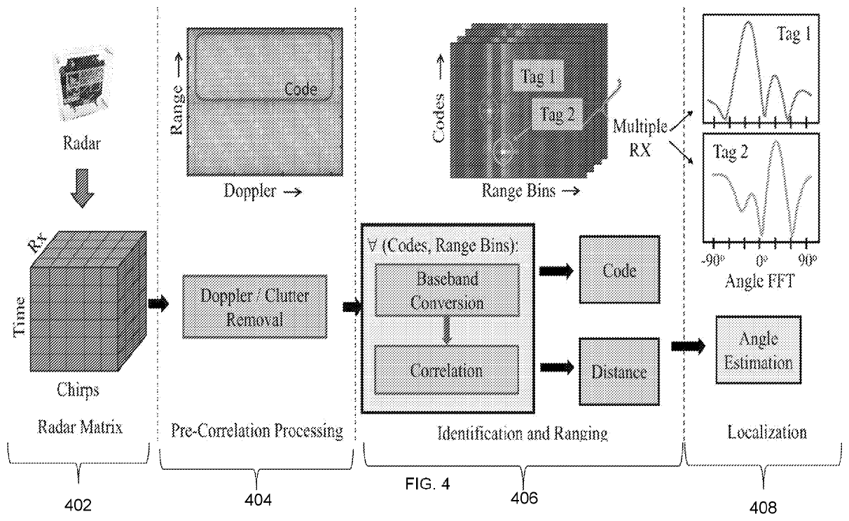

FIG. 4 shows a radar processing flow in a preferred decoder of the invention. The received signal from the radar provides a radar matrix during reception phase 402 and then is preprocessed to remove doppler and static clutter in a phase 404. The next phase 406 jointly solves for identifying the correct code and distance from the radar. The correlation values for the identified tags across multiple receivers are used to estimate the angle of each tag, thus providing the locations in the final stage 408.

The present backscatter fiducial tag with code-based modulation can be detected and uniquely identified by existing automotive radars when programmed to recognize the tags. Specific preferred algorithms can detect one or more tags and then localize them accurately i.e., find the distance and angle of the tag with respect to the radar in phases 406 and 408.

### Identifying and Ranging the Tag Using Cross-Correlation

Chirps reflected from the tag contain the modulating signal m(t) in the radar's received signal. Upon dechirping the received signal at the radar, the dechirped signal contains the tag reflection D_{mod}(t)=m(t)cos[2πΔt] where Δ is the frequency corresponding to the distance of the tag from the radar. The decoder can decompose the tag reflection as follows.

$$\begin{matrix}{D}_{m o d} ( t ) = c ( t ) ( \frac{2}{π} cos [ 2 π {f}_{m} t ] cos [ 2 πΔ t ] ) \\ = \frac{c ( t )}{2 π} ( {e}^{j 2 π ( {f}_{m} + Δ ) t} + {e}^{- j 2 π ( {f}_{m} + Δ ) t} + {e}^{j 2 π ( {f}_{m} - Δ ) t} + {e}^{- j 2 π ( {f}_{m} - Δ ) t} )\end{matrix}$$

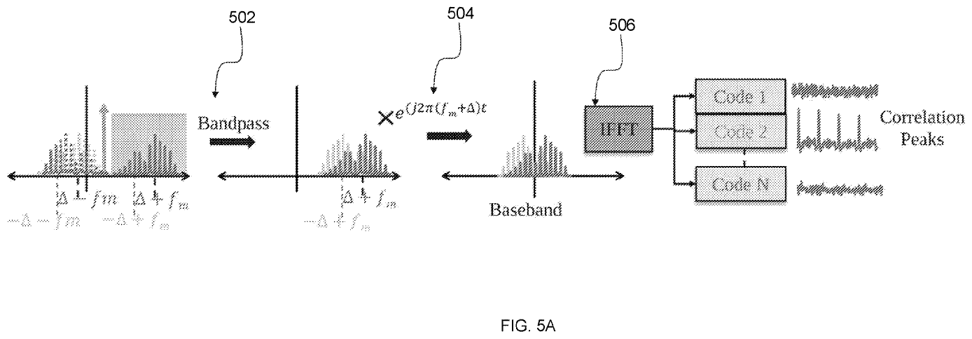

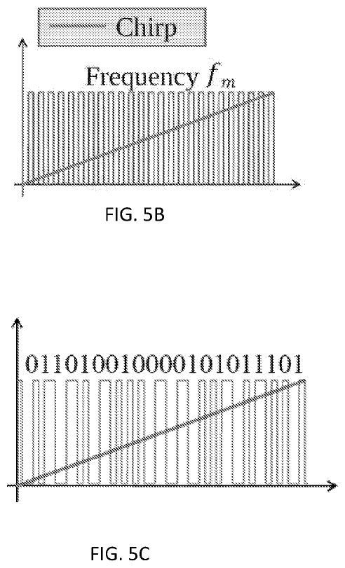

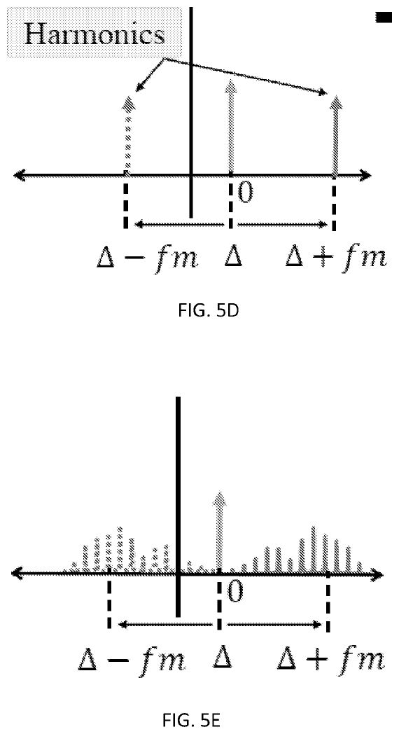

FIG. 5A shows the general correlation process. The received backscattered signal from the tag contains 4 copies of the code in the frequency domain due to aliasing. The component at Δ+fₘ is retrieved using bandpass filtering and then converted to baseband. The time-domain version of the signal is then correlated with all the codes in the codebook for identifying the tag. The right plot shows the gram matrix for correlation between different codes for a 33 gold code sequence.

The tag's reflected signal at radar contains multiple copies of code c(t) centered at different frequencies fₘ+Δ, fₘ−Δ, −fₘ+Δ, −fₘ−Δ. Given the received samples at the radar D_{mod}(t), how do we identify that the spectrum contains the code c(t)? The challenge is that there are two unknowns for each tag: the distance of the tag (captured in A) and the identity of the tag (capture code in c(t)). The received signal also consists of multiple reflections from the environment.

The spectrum of the received signal can be analyzed to jointly solve for the tag-radar separation and the identity of the tag by leveraging the present code construction that makes the codes modulated by differently coded tags are orthogonal to each other. A cross-correlation with the code itself reveals whether the code exists in the reflected signal or not. Computing cross-correlations of received samples with a code that is present in the received samples creates a high cross-correlation with periodically repeating peaks in it. However, a straight-forward cross-correlation of D_{mod}(t) with the correct code c(t) product correlation due to the following reason: there are 4 different copies of the code in D_{mod}(t) with a frequency offset term on each of them that corrupts the correlation.

A good cross correlation between the received signals and code can be obtained by eliminating the frequency offsets. Frequency offsets are not known because Δ, which is proportional to tag-radar distance, is unknown. A preferred approach to jointly solve for both Δ and the code that is present on the backscatter signal uses an iteration over the possible range of values that Δ can take.

To remove the effect of the frequency offset, the decoder can process the samples of D_{mod}(t) before taking cross-correlation. The first step of this processing is to filter out the terms that would lead to bad correlation. The code copy centered at fₘ+Δ has spectrum in the frequency range A to 2fₘ+4 whereas the code copy centered at fₘ−Δ has spectrum in the frequency range −Δ to −2fₘ−Δ as illustrated in FIG. 5A. These two copies have no common frequency content and are perfectly separable in frequency. Code copies centered at fₘ+Δ, fₘ−Δ are in close proximity with each other. Similarly, code copies centered at −fₘ+Δ, −fₘ−Δ are close to each other. So, first we pass the samples of D_{mod}(t) through a bandpass filter 502 of bandwidth 2fₘ as shown FIG. 5A to eliminate the code copies centered at −fₘ+Δ, −fₘ−Δ and retain the copies centered at fₘ+Δ, fₘ−Δ in the filtered signal.

FIGS. 5B-5E shows how a preferred tag code is constructed for automotive radar. Most automotive radars use frequency modulated carrier waveform (FMCW or chirp signal) to measure the reflection from the environment. A chirp signal of bandwidth B and duration T generated by the radar is given by

$${S}_{T} ( t ) = cos [ 2 π ( {f}_{0} t + \frac{B}{2 T} {t}^{2} ) ] .$$

For a tag/object that is present at a distance d from the radar, the chirp signal reaches the tag, reflects, and reaches back to the radar traveling a round trip distance 2d. FIG. 5B shows a square wave over a chirp. FIG. 5C shows a code waveform, and FIG. 5D. 5D the harmonics of square wave modulation. FIG. E shows that the preferred tag uses PN sequences to provide unique signatures to the backscattered signals trip travel delays the received chirp by

$$τ = \frac{2 d}{c} .$$

So, the received chirp signal is given by

$${R}_{T} ( t ) = cos [ 2 π ( {f}_{0} ( t - τ ) + \frac{B}{2 T} {( t - τ )}^{2} ) ]$$

At the receiver, an RF mixer down-converts the received chirp by multiplying it with the transmitted chirp signal and is low pass filtered to leave only the baseband signal. The output signal D(t) after the mixing operation corresponds has frequency shift proportional to the time-of-flight

$$Δ = \frac{B}{T} τ .$$

The time of flight is calculated from the frequency of the D(t) and distance d of the tag to the radar can be calculated.

$$\begin{matrix}D ( t ) = {S}_{T} ( t ) {R}_{T} ( i ) \\ = cos [ 2 π ( {f}_{0} t + \frac{B}{2 T} {t}^{2} ) ] \times cos [ 2 π ( {f}_{0} ( t - τ ) + \frac{B}{2 T} {( t - τ )}^{2} ) \\ = \frac{1}{2} cos [ 2 π ( \frac{B}{T} τ t + {f}_{0} τ - \frac{B}{2 T} {τ}^{2} ) ] \\ = \frac{1}{2} cos [ 2 πΔ t + {θ}_{τ} ]\end{matrix}$$

Filtered Signal=c(t)[e^{j2π(f}^{ₘ}^{+Δ)t}+e^{j2π(f}^{ₘ}^{-Δ)t}]

The next step 504 removes the frequency offset factors in the filtered signal by shifting the code copy centered at fₘ+Δ to zero frequency. This is achieved by multiplying the filtered signal with e^{-j2π(f}^{ₘ}^{+Δ)t} leading to x(t):

x(t)=c(t)+c(t)e^{j2π(-2Δ)t}

The resulting signal x(t) contains the desired signal c(t) and an additional term with a frequency offset of 24 which can be called the image signal. When x(t) is correlated with the correct code sequence c(t), the first term c(t) results in a periodic impulse train. The image signal c(t)e^{j2π(-2Δ)t} contains a frequency offset of 2Δ that increases with the tag to radar separation. Because of the frequency offset, its cross-correlation becomes smaller as the tag to radar separation increases.

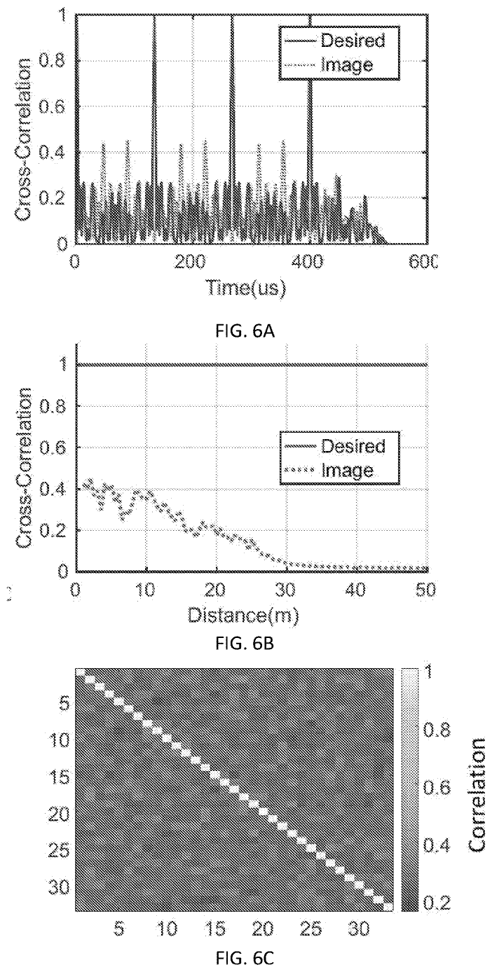

FIGS. 6A-6C empirically show that the cross-correlation contribution from the image signal becomes smaller as A increases. FIG. 6A shows normalized cross-correlation for 2m tag to radar separation. FIG. 6B shows peak value of cross-correlations as a function of distance. In FIG. 6B the image signal's contribution to the cross correlation reduces gradually as tag to radar separation increases. FIG. 6C is a gram matrix showing the auto-correlation and cross-correlation of 31 bit Gold codes.

When x(t) is correlated with an incorrect code, it leads to a poor cross-correlation. The process can therefor cross-correlate x(t) with all the possible codes and find the set of codes that result in an impulse train like cross-correlation and declare the codes that are present in the backscatter signal. A preferred process stores the highest peak of the cross-correlation in a 2D matrix over all the range bins and the codes. The highest value in this 2D matrix jointly provides the tag to radar separation and the code that is present in the backscatter signal.

The fast movement of a vehicle during a chirp duration causes the received chirp to be slightly shifted in a frequency proportional to the carrier frequency and the velocity of the vehicle (doppler effect). This shift in frequency manifests as a shift in the code spectrum by few bins in the range FFT 406 (FIG. 4). The present joint decoding algorithm iterates over all possible shifts, which permits identification of a tag by its code. The shift in the spectrum introduces the error in the estimated tag to radar separation. The present decoding scheme does not require template matching in the range doppler domain, so the radar will never confuse doppler arising from a vehicle and the code spectrum. Experiments have simulated the doppler scenario for up to 100 mph speeds, which showed that doppler results in a maximum error of 2 meters.

### Combining Across Multiple Chirps

Decoders of the invention include versions that combines radar samples from multiple chirps to improve noise performance. The multiple chirp decoding is particularly useful with radars that use digital beamforming. Multiple chirp decoding makes the decoding more robust to noise present in the backscattered signal. Multiple chirp combining can also extend the distance range over which tag codes can be detected.

The strength of the fiducial tag's backscatter signal inversely varies with the fourth power of the tag to radar separation

$$( ∝ \frac{1}{{d}^{4}} ) .$$

To put this signal power variation into perspective, if the tag to radar separation is doubled, the received signal power drops by 12 dB. This implies the reflected signal power can quickly hit the receiver noise floor and the characteristic peaks in the cross-correlations will be buried in the noise floor. Reliable long-range tag detection benefits from an enhanced the Signal to noise ratio (SNR) of the received signal when the decoder evaluates the received backscattered signal over multiple chirps.

Multiple radar samples from multiple received chirps can make the periodic peaks in the cross-correlation stand out from the noise. Typically, radars have a gap time between two consecutive chirps and the decoder fills the gaps between the chirps with zeros and append multiple chirp samples. Then the decoder performs cross-correlation with the code sequence to detect the peaks and thus identify the code that is present. Cross-correlation on these appended samples is equivalent to averaging over noise samples to reduce the noise power which gives us the processing gain. So, combining L chirps reduces the noise power by a factor of L and results in a processing gain of 10 log₁₀(L) dB. A threshold can be set based on the peak-to-noise ratio for detecting the presence of a particular code. Any correlation value greater than the threshold is then marked as a positive code detection.

### Latency of Operation

The processing gain or the improvement in SNR logarithmically increases with the number of chirps processed together. The present decoding offers the flexibility to choose the number of chirps for coherent processing. The latency of the system is independent of the number of tags present as the system always searches for the presence of all codes. The low latency operation of the backscatter fiducial code is particularly useful in the case of radars that use beamforming-based scanning. Such radars send a single chirp in different directions in space to scan the environment. For these radars to detect the tag, it is important to complete the modulation within a single chirp duration, and the present decoding can be configured for such single chirp detection.

### Localizing Tags

The decoder localizes a tag by estimating its angle. Distance and angle of tag provide the decoder with location of the tag. To estimate the angle of the tag, multiple receivers in the radar unit are used. Based on the signal's angle of arrival (AoA), each subsequent receive antenna in the linear array receives an additional phase induced by an extra path length of

$$\frac{d sin ( θ )}{λ} ,$$

where d is the separation between the two receive antennas and θ is the AOA.

A signal reflected from any object appears as a constant sinusoidal tone in a particular frequency bin of the range FFT spectrum of the radar. To estimate the angle of arrival for this signal, the value at the corresponding bin is picked across multiple receiving antennas and an FFT over these values is used to determine the angle. However, the frequency spectrum due to the tag's backscatter is spread over a bandwidth of 2fₘ.

This challenge can be overcome by the decoder using the signal obtained after the correlation with the correct code across multiple antennas. The phase difference induced due to the difference in path lengths at different receivers is preserved during the cross-correlation. Taking angle FFT of correlation peak values at multiple antennas allows selection of the peak values in the angle FFT and in turn estimate AOA. The estimate of AOA together with the distance of the tag provides the location of the tag. Resolution of AOA is dependent on the number of available receivers on the radar. Typical automotive radars contain large receive antenna arrays, which can be used to improve the angular resolution.

### Backscatter Fiducial Tag Hardware and Prototypes

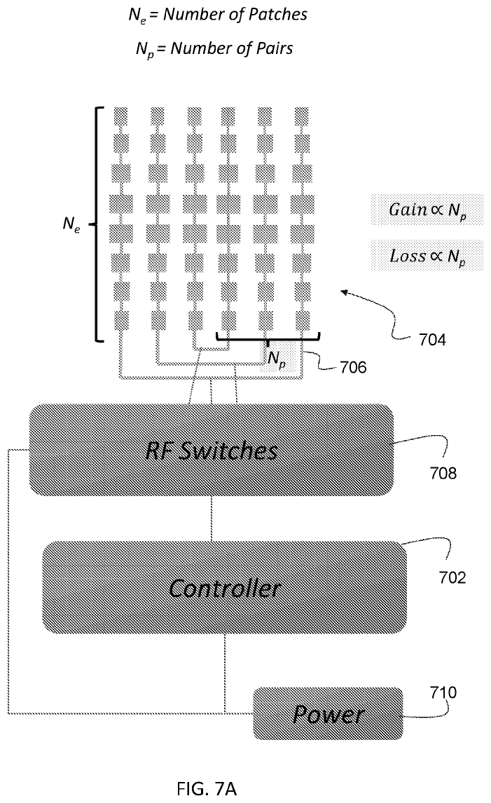

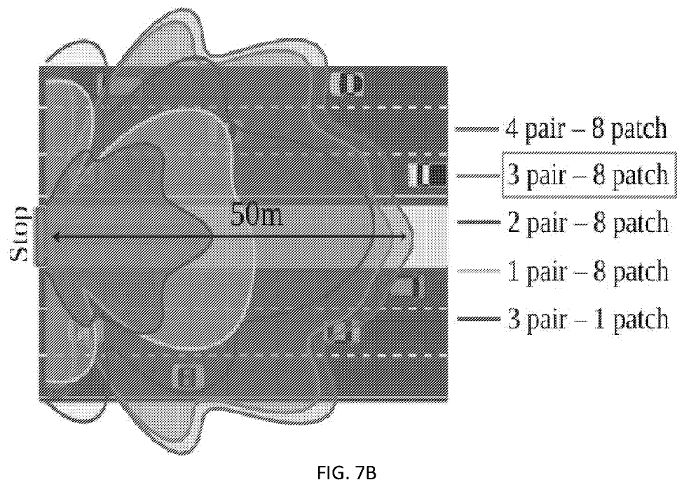

FIG. 7A shows preferred backscatter fiducial tag hardware that consists of a control circuit 702, Van Atta Array antennas 704 that are connected by transmission lines 706, RF switches 708 to modulate the backscattered signal, and a power source 710, such as a battery which could also include a solar cell for recharging. The power source 710 powers the control circuit 702 and the RF switches 708. The design of the antennas 704 and transmission line connections 706 affects the width and distance of the tag's reflected signal, as shown in FIG. 7B. A control circuit 702 can be a low power microcontroller, as used in experiments, but can be simplified to even further reduce negligible power requirements of the control circuit. A preferred control circuit 702 consists of a fixed shift register outputting a repeating sequence of Gold code bits to modulate the tag. A microcontroller was used in a prototype to provide more flexibility in terms of testing the tag.

A preferred design includes Nₑ=8 Nₚ=3 for the antenna array and transmission lines. The 3 pair van atta architecture is preferred for its wide coverage. More than 3 pairs provide diminishing returns. 8 patches per antenna provide a more significant improvement in gain compared to 4 patches per antenna while 16 patches per antenna are less beneficial due to narrowing the field of view of radar.

### Prototype Information.

In example prototype tags of the invention, the antennas used on the tag are patch antennas which are directional in nature. The antennas are designed to have a 50 ohm impedance over a frequency range of 24 GHz to 24.3 GHz to cover the 24 GHz ISM frequency band. Each antenna has a 14 dBi peak gain and 100 degree horizontal field of view to support long range and wide field of view. A printed circuit board (PCB) used for the antenna, control circuit and RF switches is designed on a 20 mil Rogers 4003c dielectric as a substrate to minimize the RF trace losses.

A prototype control circuit is an onboard PSoC 6MCU (Microcontroller unit). Two Linear feedback shift registers (LFSR) were implemented on the MCU to generate the gold code sequence. The generated bits are outputted from a GPIO pin and are fed to the RF switch as the control signal. The LFSRs can be configured to use different length codes. In a prototype implementation, we use 5-bit LFSRs to generate 32-bit codes.

To modulate the information on the tag, we design the tag to switch between van-atta and absorbing states. To achieve two different states for the tag, we use an RF switch on each transmission line that connects a pair of antennas. When the RF switch is turned on, the connection between the antenna pairs is established and the incident signal is retro-reflected, providing high RCS to radar. When the RF switch is turned off, the transmission line ends are terminated in a 50 ohm microwave resistor and the incident signal is completely absorbed by the tag, providing lower RCS. In this manner, the RCS value could be controlled by using the switch, based on the information sent and the radar could discern the information from these fluctuations. In our prototype implementation, we used the MASW-011105 RF switch from MACOM due to its low insertion loss (1.6 dB) at 24 GHz and low DC power consumption of 5 uW.

Power consumption of the backscatter fiducial tag is from the RF switches, which are the primary active elements and control modulation of the backscattered signal. The micro-controller is near passive, consuming negligible The power consumption of an RF switch consists of two components (a) Static and (b) Dynamic power. Static power consumption of the circuit is caused by the leakage current in all the circuit components. In the prototype, the RF switches are operated at a supply voltage of 5v and draw a continuous current of 1 μA from the supply thus consuming a static power of 5 μW. Dynamic power is due to the energy dissipated in the charging and discharging of capacitors in a circuit. So, dynamic power depends on the rate of switching. In the prototype, commercial switches had a dynamic power of 140 μW at 250 kHz switching rate. The tag consumes a total of 145 μW of power, dominated by the dynamic power consumption. The dynamic power is also the function of the input power of the switch. Typical commercial RF switches are designed to handle input power levels at 1 watt and thus they require transistors within them that can handle very high current. To handle high RF power, transistors with large gate sizes are used which significantly rises the input capacitance resulting in high dynamic power. In backscatter applications where the present backscatter fiducial tag is used, the incident RF signal power levels are of the order of a few μW, eliminating the need for large transistors. Hence by designing the RF switches on Application-Specific Integrated Circuits the dynamic power can be significantly reduced in a production version of the present tags. A tag of the invention is expected to should consume power less than 30 μW and can last for two years on a typical coin cell battery CR2032. Two years is the periodic maintenance time based on the federal highway administration report 7. Rechargeable batteries and solar cells can also be used, particularly in outdoor environments.

Prototype Code Design and Radar parameters: A 24 GHz DEMORAD radar platform from analog devices was tested that provides chirp samples at a 1 MHz rate. It is a MIMO radar with 2 transmit and 4 receiver antennas. In testing, one transmit and 4 receive chains were used to collect the data and estimate the angle of arrival to find the tag's angular location. For the tag identification, the tag's backscatter signal was modulated using 31 bit Gold code sequences. These Gold code sequences are generated on the tag using a 5-bit linear feedback shift register. The code sequence is modulated at 250 kHz modulation frequency fₘ to satisfy the bandwidth constraint. There exist 31 gold sequences of 31-bit length with good cross-correlation properties the example prototype therefore could support 4 different tags that are located in the vicinity of each other. In our experiments, we configure the radar with an upchirp time of 496 μs and a gap time of 104 μs between two chirps. We fill this gap time with zeros in-order to provide processing gain by combining samples from multiple chirps.

### Multiple Tag Scalability

Scalability in terms of the number of tags with unique codes that can operate simultaneously is enabled by the present backscatter fiducial tags. During the operation, the correlation-based detector will find the correlation of all the codes in the codebook with the signal received. A threshold of detection can be set in the multiple tag evaluation. The value of the threshold determines how many detections are made. If any correlation value exceeds the threshold, the corresponding code, and hence the tag, would be marked present. A lower threshold means more detections and possibly more false positives and vice versa for a higher threshold. To evaluate the performance in the case of multiple tags, testing used the AUC (area under the curve) metric. The true positive rate is plotted against the false-positive rate for different threshold values. The area under the curve then determines the performance of the detector.

Detection performance and latency: For this experiment, three tags with different codes at separate locations in three different configurations within a range of 10 m from the radar were used. Different configurations cover cases of wide-angle separation (config 1) to closely spaced tags (config 3). The distance of the radar from tags also increases in each subsequent configuration. 100 frames were captured for the experiment in each configuration, and both the true positive rate against the false-positive rate were plotted.

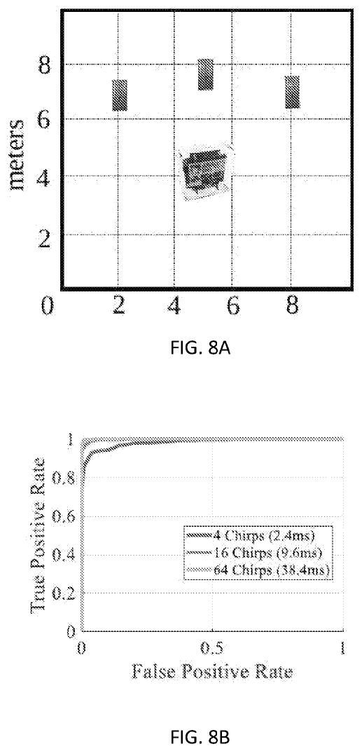

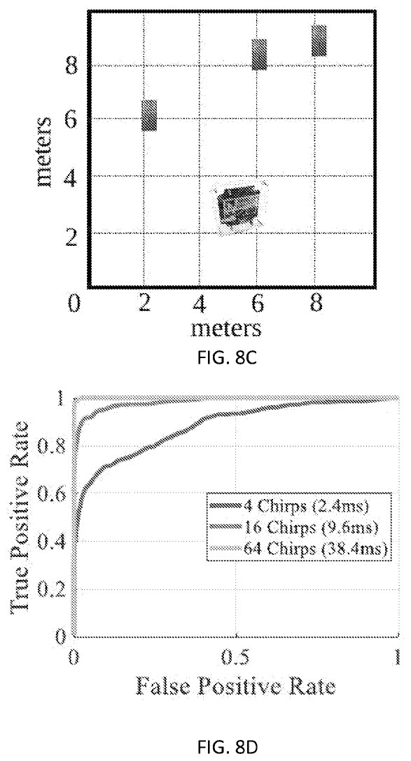

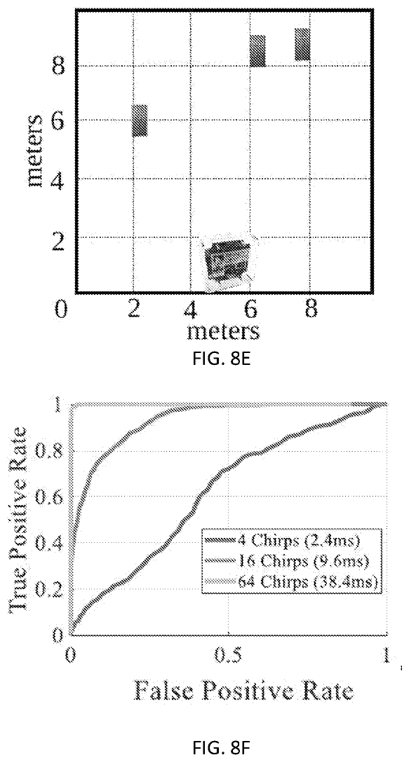

FIGS. 8A-8F show curves for the performance of detection and identification in the presence of multiple tags. Table 1 shows the AUC calculated for each configuration for different chirp combinations. As expected, combining a large number of chirps (64) provides an almost perfect AUC. For smaller distances in FIGS. 8A-8B (config 1), using even a small number of chirps obtain a good AUC value. Even when the tags are closely placed, they can be clearly detected separately. Note that the latency of operation is completely independent of the number of tags present in the environment. As mentioned above, the decoder checks for the presence of all the codes in all distance bins regardless of the number of tags. Every code and distance bin that gives a high correlation marks the presence of the tag.

| | AUC | | |
|---|---|---|---|
| | 2.4 ms | 9.6 ms | 38.4 ms |
| Config 1 | 0.985 | 0.998 | 0.999 |
| Config 2 | 0.887 | 0.986 | 0.999 |
| Config 3 | 0.627 | 0.937 | 0.999 |

### Advantages of Present Backscatter Fiducial Tags and Decoders

The present tags and decoding provide very low latency, as small as a single chirp and scalable to a few or more chirps for longer distance detection and better noise reduction. This can be critical in automotive applications. The present tags can be identified withing a few milliseconds using standard commercial radar.

The present tags and decoding provide asynchronous operation. As there is no physical link between the reader and the tag and the latency should be very low, the tags of the invention and the decoder do not require any synchronization or knowledge of radar timing parameters for operation.

With a preferred antenna array design, the tags permit detection of their codes from wide range of angles and wide range of distances. In the case of automotive radar as a reader, both transmitters and receivers are at the same place, so the signal reflected from the tag should reflect a reasonable amount of power back in the same direction. This is true for a wide range of angles with proper antenna array design in the tag.

While preferred embodiments have been described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A wireless backscatter fiducial tag, comprising:
a Van-Atta array having a plurality of antenna patches connected by a plurality of transmission lines;
a signal control device controlling transmissions from the Van-Atta array;
a controller providing an identification signature of the tag to the signal control device, the identification signature comprising a code.

2. The backscatter fiducial tag of claim 1, wherein:
the signal control device comprises RF switches; and
the code comprises a spreading code configured to be orthogonal to codes of other backscatter fiducial tags being used in a system with the backscatter fiducial tag.

3. The backscatter fiducial tag of claim 2, comprising a power source providing power to the signal control device and the controller.

4. The backscatter fiducial tag of claim 2, wherein the spreading code comprises N-bit sequence that takes values in +1,0 with auto-correlation that is much better than cross-correlation with other spreading codes used in the system.

5. The backscatter fiducial tag of claim 2, wherein the controller further provides a flashing modulation to the RF switches.

6. The backscatter fiducial tag of claim 5, wherein the flashing modulation continuously repeats the spreading code.

7. A system including a plurality of backscatter fiducial tags of claim 1, each with its code and a radar transceiver with a decoder, wherein the decoder includes a library of the codes of the plurality of backscatter fiducial tags and conducts cross-correlation of all codes in the library to identify a particular code that was received.

8. The system of claim 7, wherein the controller of each of the plurality of backscatter fiducial tags creates a modulation signal m(t) that is modified to contain the code as an N-bit code in which each bit modulates the phase of a square wave pattern.

9. The system of claim 8, wherein a bit of value 1 corresponds to the ON to OFF transition in the codes with period
$$\frac{1}{{f}_{m}}$$
and a bit of value 0 corresponds to OFF to ON transition of the tag with period
$$\frac{1}{{f}_{m}}$$
or vice versa, wherein fₘ is the modulation frequency.

10. The system of claim 9, wherein each bit has a period equal to T_{bit}=1/fₘ and occupies a bandwidth of
$$\frac{2}{{T}_{b i t}} = 2 {f}_{m}$$
such that a bit sequence c(t) occupies is made up of N bits and occupies a total bandwidth of 2fₘ and the modulation signal m(t) is the bit sequence c(t) multiplied by the square wave of the modulation frequency fₘ.

11. The system of claim 10, wherein m(t) contains copies of c(t) centered at fₘ and −fₘ thus occupying a total bandwidth of 4fₘ.

12. The system of claim 11, wherein each code contains N-bits each of duration
$$\frac{1}{{f}_{m}}$$
and occupies a length of N/fₘ, wherein the chirp duration T_{c} is greater than k code durations according to the timing constraint given by the following inequality:
$${T}_{c} > k \frac{N}{{f}_{m}} ⟹ {f}_{m} > k \frac{N}{{T}_{c}}$$
and bandwidth constraint defined by the inequality:
$$4 {f}_{m} < {f}_{s} ⟹ {f}_{m} < \frac{{f}_{s}}{4}$$
wherein the modulation frequency fₘ is selected to satisfy each of the timing constraint and the bandwidth constraint for a chirp duration and the radar transceiver and its sampling frequency.

13. The system of claim 7, wherein the radar transceiver and decoder preprocess a received a radar matrix to remove doppler and static clutter, then jointly solve for identifying the correct code and distance from the radar, wherein correlation values for identified tags across multiple receivers of the radar transceiver are used to estimate the angle of each tag to provide locations of detected tags.

14. The system of claim 7, wherein the decoder removes frequency offset prior to conducting cross-correlation.

15. The system of claim 14, wherein the frequency offset is removed by filtering code copies centered at −fₘ+Δ, −fₘ−Δ, wherein Δ is time of flight.

16. The system of claim 15, wherein the transceiver and decoder down-converts a received chirp by multiplying it with a transmitted chirp signal and then low pass filtering to provide an output signal D(t) having a frequency shift proportional to the time-of-flight Δ=B/Tτ, wherein the time of flight is calculated from the frequency of the D(t) and distance d of the tag to the radar.

17. The system of claim 7, wherein the transceiver and decoder use multiple chirps to conduct cross-correlation.

18. The backscatter fiducial tag of claim 1, wherein the Van-Atta array comprises three transmission lines connected pairs of eight antenna patches.

19. The backscatter fiducial tag of claim 1, wherein the controller and the code are configured to be transmitted within a single chirp of a radar signal.

20. The backscatter fiducial tag of claim 19, wherein the code is selected from a set of Gold codes.

21. The backscatter fiducial tag of claim 1, attached to a traffic control device, wherein the code is selected to correspond to the traffic control device.

22. The backscatter fiducial tag of claim 1, wherein the controller consists of a fixed shift register outputting a repeating sequence of Gold code bits as the identification signature.
